(19) United States
(12) Patent Application Publication
(10) Pub. No.: US 2012/0243830 A1
(43) Pub. Date: Sep. 27, 2012

(54) FIBER OPTIC ALIGNMENT SYSTEM AND METHOD AND CONNECTOR ASSEMBLY

(75) Inventors: Michel Y. Rondeau, Hayward, CA (US); Israel Miranda, Hayward, CA (US); Richard Lam, San Francisco, CA (US)

(73) Assignee: Valdo Fiber Optics, Inc., Hayward, CA (US)

(21) Appl. No.: 13/072,292

(22) Filed: Mar. 25, 2011

(51) Int. Cl. G02B 6/40; B23P 11/00

(52) U.S. Cl. 385/54; 29/428

(57) ABSTRACT

A fiber optic connector assembly (10) for a bundle (22) of fibers (20) is provided. The connector assembly (10) includes an opposing pair of keyed end assemblies (19) and a keyed housing (34) for receiving them. Each keyed end assembly (12) includes key ring (30) with a projecting tab (31) departed to mate with a key slot (32) in the keyed housing (34). A method for aligning the fibers (20) in the bundle (22) using an alignment guide (48) is provided to assemble the connector (10).

This is a non-provisional application, claiming priority from provisional application No. 61/131,303, filed on 27 Mar. 2010 by the same inventors.

### TECHNICAL FIELD

The present invention relates generally to fiber optic cabling and to connectors therefor

### BACKGROUND ART

The present inventor Rondeau has previously developed fiber optic connectors and related inventions as set forth in U.S. Pat. Nos. 5,216,735, 5,305,408, 5,502,784, 5,548,674, 5,822,483, 6,000,857 and 7,048,446.

Fiber optic data transmission technology has become a principal form of reliable and rapid communication in the modern world. Fiber optic cables, both in single form and bundled form are widely used in all areas of industry and technology.

It is frequently desirable to utilize bundles of fiber optic cables formed into a single cable. This occurs commonly in circumstances where a single controller element, such as a CPU or network switch is used to deliver signals to multiple devices or nodes on devices. Additionally, it is occasionally desirable to utilize a single multi-fiber cable to handle communications between diverse devices located in similar locations to remote locations with similar circumstances.

A difficulty with multi-fiber cables can occur when there are alignment issues and problems determining just which fiber corresponds to which signal.

Accordingly, prior to the present invention there was a significant need for improvement in the constructions and alignment of multi-fiber fiber optic connectors.

### DISCLOSURE OF INVENTION

Accordingly, it is an object of the present invention to provide a method for precisely aligning opposed bundles of optical fibers in a secure connector element.

Another object of the invention is to provide a method for orienting groups of fibers into precise and stable radially-arrayed bundles, with each discreet fiber having a specific position in the radial array.

A further object of the present invention is to provide a secure bonding of discreet fibers into a ferrule to maintain a consistent radially arrayed bundle having truncated ends co terminal with said ferrule.

Yet another object of the invention is to provide a key ring on each ferrule with the key ring providing precise radial alignment with a designated fiber in the bundle and facilitating optimal alignment in the connector.

Another object of the invention is to provide a fiber optic connector assembly wherein opposing ferrules are maintained in optimal alignment by resilient inward force.

Still another object of the invention is to securely protect the severed end of the fibers within a ferrule to prevent damage and loss of orientation.

Yet another object is to provide a spring force to maximize the degree of engagement within the connector.

Briefly, one preferred embodiment of the present invention is a method for assembling fiber optic cables into keyed bundle connector elements in order to achieve optimal alignment and data throughput. The method includes the sequential steps as follows. A) Orientation of fibers into a prescribed array; B) Bonding the oriented fibers into a directionally-identified ferrule (Impact Mount Tube—IMT); C) Orienting and securing a key ring to each ferrule, the key ring including a projecting tab oriented to a specific fiber; D) Inserting paired ferrules into opposing ends of a keyed housing with the projecting tabs being received into corresponding slots on the keyed housing to achieve mutual alignment; and E) Securing the ferrules in the bulkhead by resilient inward axial pressure in the form of a spring.

A physical preferred embodiment of the present invention is a fiber optic connector assembly for achieving rapid and consistently optimally aligned fiber optic bundle junctions. The assembly is adapted to connect the fibers in an opposed pair of specially assembled and directionally keyed end assemblies. Each end assembly encompasses an orientation guide used orient a group of fibers into a specific radial bundle array, with identified individual fibers. The oriented fibers are then placed and crimped within a ferrule to secure the position. In some deluxe embodiments a ferrule holder is placed around and secured to the ferrule. A key ring is secured to each ferrule (or ferrule holder) with a projecting tab precisely aligned with an identified one of the fibers, correspondingly rotationally locating each fiber in the bundle. Each ferrule mates with a keyed housing having a key slot at each end to receive the projecting tab such that corresponding fibers from the opposing ferrules are precisely aligned. Resilient inward force maintains the alignment and positioning of the ferrules within the keyed housing; in the deluxe preferred embodiment by compression springs within bayonet caps associated with each ferrule which mate with a central bulkhead secured to the keyed housing. In some alternate embodiments, the housing is itself rotationally keyed so that it will insert in only one orientation into a receiving slot, rather than mating directly with another connector, and no spring action is required.

An advantage of the present invention is that it provides rapid and optimal alignment for multi-fiber bundles in connectors.

Another advantage of the invention is that it provides clearly identified opposing optical fiber ferrules with mirror-image fiber arrangements

An additional advantage of the invention is that it provides securing caps to hold the connection in alignment and provides inward resilient force for maintaining alignment.

Yet another advantage of the present invention is that the key rings precisely locate a designated fiber (and consequently each fiber) in a bundle for optimal alignment purposes.

Still another advantage of the present invention is that it results in an easily assembled and securely retained optical fiber connection.

A still further advantage of the invention is that an alternate embodiment is adapted to snap fit into a receiving slot with precise orientation.

These and other objects and advantages of the present invention will become clear to those skilled in the art in view of the description of the best presently known modes of carrying out the invention and the industrial applicability of the preferred embodiments as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 is cross sectional view of a completed connector assembly according to one embodiment of the present invention;

FIG. 2 is perspective view of an orientation guide, with oriented fibers;

FIG. 3 is side elevational view of a typical end assembly according to one embodiment (KSP) of the invention,

FIG. 4 is a perspective view of and extended version of the end assembly of FIG. 4;

FIG. 5 is an end view of an end assembly, showing the oriented fibers;

FIG. 6 is a side view of a pair of end assemblies joined into a completed connector according to an alternate embodiment (KSP) of the invention;

FIG. 7 is an exploded view of a further alternate embodiment (KSC) of an end assembly according to the invention; and

FIG. 8 is top view of a fully assembled KSC connector.

### BEST MODE FOR CARRYING OUT THE INVENTION

The present invention is a method for aligning an array of fiber optic cables and a type of connector assembly for fiber optic cables 10 in accordance with the method.

The method of the invention involves a variety of steps to assure proper orientation and connection.

Firstly, in Step A the individual fibers are identified and inserted into an orientation guide in proper sequence. For a seven fiber bundle (circular closest packing array) the fibers are arrayed with fibers one (I) through six (VI) radially arrayed around the outside of fiber seven (VII) in the center of the bundle. The fiber bundles are pre-identified as being “left/blue” and “right/red” bundles with the fibers being sequentially arrayed clockwise in the left bundle and counter-clockwise in the right bundle.

Secondly, in Step B the right and left oriented bundles are bound into Impact Mount Tubes (IMT ferrules) with the fiber ends being aligned with the end of the ferrule and the IMT ferrule rigidly holding the bundle in the pre-arranged rotational orientation in the interior portion of an end assembly. Color coding or similar identification is typically utilized to clearly identify left and right ferrule and the enclosed bundles. A mark may be placed on the exterior of each end assembly to show the location of fiber one (I).

Thirdly, in Step C each end assembly is formed to include an IMT ferrule which is provided with a key ring, with the key ring having a projecting tab extending radially outward directly aligned with fiber number one (I). The key ring is fused into position on the exterior of the IMT ferrule at a location inset from the fiber ends. In some embodiments, the ferrule may first be provided with a ferrule holder (with or without an extension) with the key ring actually engaging the exterior of the ferrule holder.

Fourthly, in Step D the corresponding end assemblies for a left bundle and a right bundle are inserted into opposite ends of a keyed housing. The keyed housing includes aligned slots for receiving the projecting tabs on the key rings. The depth of the slots is selected such that the tab abuts against the end of the slot when the respective fiber ends are at optimal separation distance. The engagement of the tabs and slots insures that fiber one (I) in each IMT will be precisely aligned with the corresponding fiber in the opposing IMT ferrule. Similarly, the tightly crimped IMT ferrule structure insures that each other fiber in the bundle will also be properly aligned with its alignment partner.

Fifthly, in Step E the orientation is maintained and secured by a compression spring within a bayonet cap (a freestanding “U” spring in one alternate preferred embodiment) which engages the end assemblies outside of the bulkhead and maintains inward axial force thereon. In a deluxe embodiment a threaded bulkhead is screwed onto the bayonet caps which are rotatably mounted about both left and right IMT ferrule components to secure the entire assembly into position.

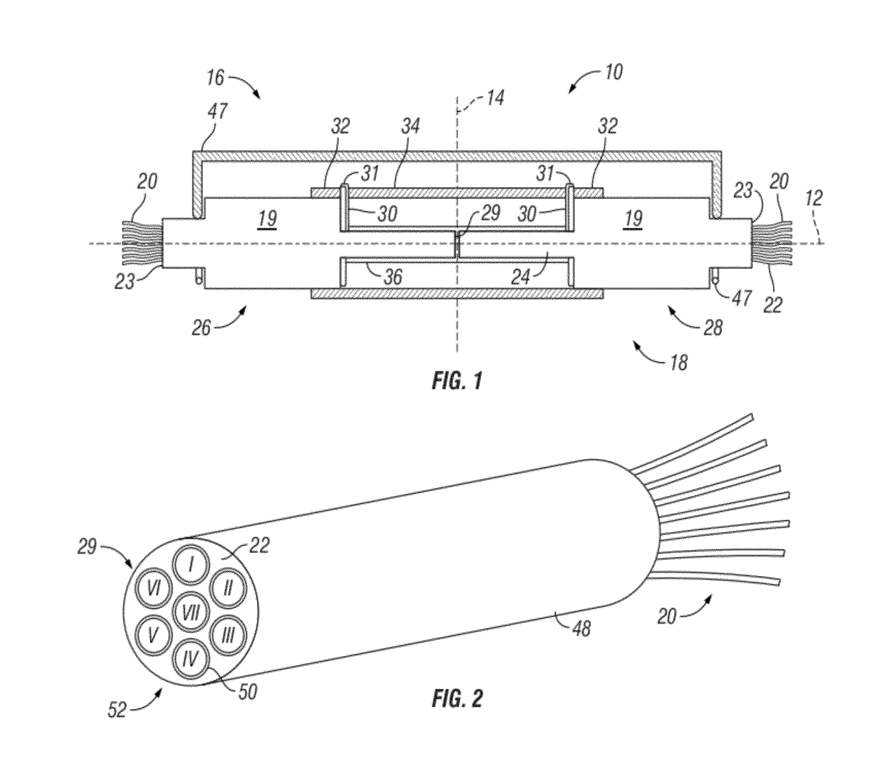

As shown in the cross sectional view of FIG. 1, one preferred deluxe embodiment of the connector assembly 10 of the present invention is generally radially symmetrical about a longitudinal axis 12 and laterally symmetrical about a bisecting plane 14, perpendicular to the axis 12. The bisecting plane 14 divides the assembly 10 into a left side 16 and a right side 18. A keyed end assembly 19 exists on each side of the connector.

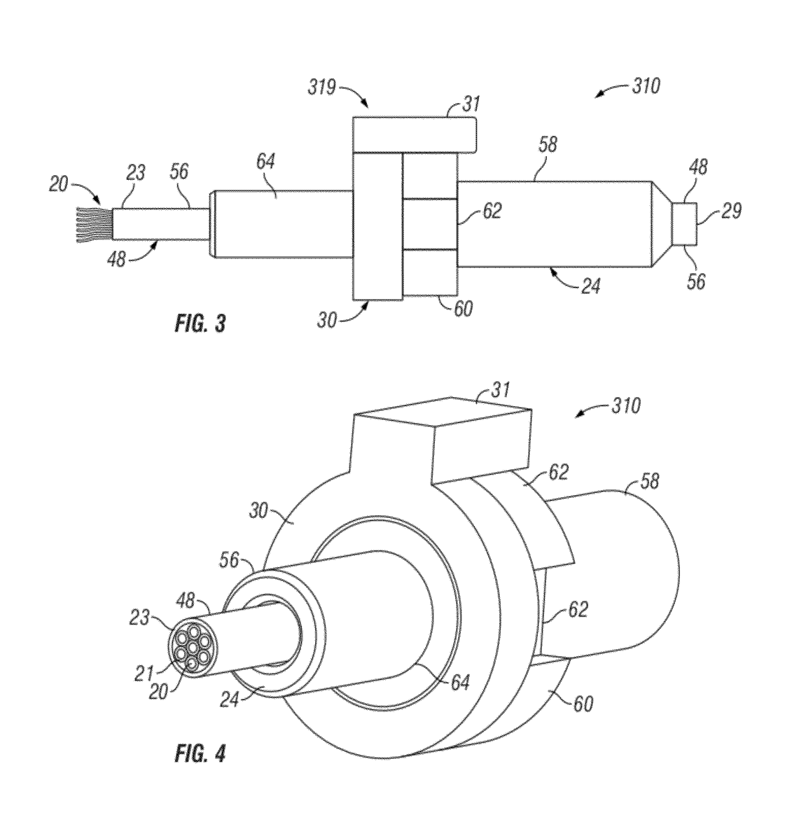

A plurality of optical fibers 20 extend from the connector 10 to and from whatever components between which communication is required in the particular installation. In the embodiment described shown in FIG. 1 the fibers 20 will be seven discreet fiber-optic elements which are shown in FIGS. 3-5 particularly and designated as 201 through 20V11. Each fiber 20 has an exposed fiber end 21 which will be directed toward the center of the connector 10 for communication purposes. The fibers 20, either separately or in a bundle 22, engage an outward end 23 of the end assembly 19 and enter a ferrule 24 (in the preferred embodiment 10 an impact mount tube ferrule or “IMT ferrule”) on each side of the connector 10. In some embodiments (see FIGS. 3-5) each ferrule is provided with a ferrule holder 25, which may or may not have an extension. As discussed below in connection with FIGS. 3-5, in the preferred embodiment 10 the ferrule 24 on the left side 16 is a blue ferrule 26 while the corresponding one on the right side is a red ferrule 28. In addition to the outward end 23 where unaligned fibers 20 enter, each end assembly 19 has an inward end 29 where the fiber ends 21 are truncated (cleaved and polished) and exposed in a co terminal fashion.

Each ferrule 24 (red or blue) is provided with key ring 30 to precisely align the blue ferrule 26 with the corresponding red ferrule 28. The key rings 30 are each provided with a projecting tab 31 adapted to engage a receiving slot 32 on a keyed housing 34. The keyed housing 34 straddles the bisecting plane and has a mutually aligned key receiving slot 32 on each end in order that both the blue ferrule 26 and the red ferrule 28 engage the key housing 34. A C-sleeve 36 may be contained in the interior of the keyed housing 34 to surround the inward ends 29 of the ferrules 24.

In the embodiment (KSP) of the connector 310 illustrated in FIG. 6, each end assembly 19 is provided with a bayonet cap 38 which is freely rotatably mounted about the ferrule 24 and fibers 20. The bayonet caps 38 are provided with male threads 40 adapted to mate with female threads 42 on a central bulkhead 44. The central bulkhead 44 may or may not be integral with or bonded to the keyed housing 34. A compression spring 46 is contained within the interior of each bayonet cap 38 to provide resilient axial force on the ferrule 24 and maximize engagement with the keyed housing 24 when the bayonet cap 38 is threaded into engagement with the bulkhead 44. The engagement is described below in the Industrial Applicability section.

In the illustration of the embodiment 10 shown in FIG. 1, the compression force is provided by a U-Spring 47 which engages each end assembly 19 and forces them together within the keyed housing 34. This configuration is desirable in a low vibration, low-impact situation, or in a temporary connection where long term security is not practical and economy is paramount. In these circumstances it may not be necessary to have the full security provided by the deluxe connector 310 and the securing mechanism of the bayonet caps 38 and the bulkhead 44 may be dispensed with and a simpler connect mechanism may be utilized. In such cases, the U-spring 47, as illustrated in FIG. 1, may be utilized to hold the connector components together. The U-spring 60 includes gripping slots at each end which are adapted to fit over bonding tubes 56 and abut against surrounding tubes 58 of the respective ferrules 26 and 28 once the connection with the keyed housing 34 and the C-sleeve 36 have been achieved. The inward force provided by the U-spring 47 thereby maintains the inward force on the components (similar to the compression spring 46 in the deluxe embodiment) to hold everything together.

FIG. 2 illustrates an alignment guide 48 utilized to organize and align the optical fibers 20 into the appropriate bundle 22 for capture within a ferrule 24. The orientation guide 48 is a tubular structure with a series of fiber tubes 50 extending therethrough in a preset arrangement. In the preferred alignment guide 48 there are seven fiber tubes 50 with six exterior tubes radially arrayed about a central fiber in a tight circular pattern.

A technician (or conceivably a suitably talented robotic component) inserts fiber ends 21 of the optical fibers 20-I through 20-VII into the orientation guide 48 in a precise pattern in accordance with the desired purpose. In the illustration of FIG. 2 the pattern is a clockwise orientation 52 (at the exit end 29 of the orientation guide 48) with fiber 20-VII in the center and fibers 20-I through 20-VI arranged in the clockwise rotation 52 about the center fiber 20-VII, as will be appropriate for a blue ferrule 26. Typically, the fibers are identified by sending a particular color though each so they can be told apart and the technician knows which fiber 20 is being inserted into which fiber tube 50.

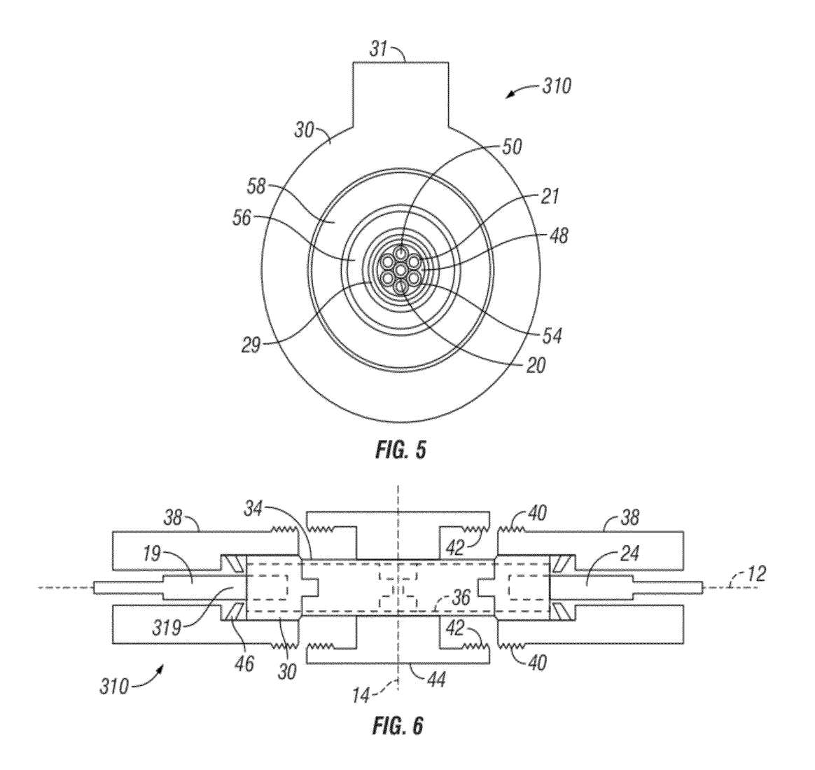

The illustration of FIG. 3 shows a side view, FIG. 4 shows a perspective view and FIG. 5 shows an end view of a (KSP) end assembly 319 including an IMT ferrule 24 which has been bonded about the orientation guide 48. In this case a (left) blue ferrule 26 has been selected which has a counter-clockwise orientation 54 of the fibers 20-I through 20-VII. When a blue ferrule 26 and a red ferrule 28 are juxtaposed in the connector 10 (see FIG. 6) the clockwise orientation 52 and opposing counter clockwise orientation 54 result in each fiber being properly aligned with its counterpart for effective signal communication.

The ferrule 24 is shown to have a narrow bonding tube 56 (SST tubing press fit) in which the fiber bundle 22 is tightly captured and a broader surrounding tube 58. The bonding tube 56 is placed about the orientation guide 48 and is shrunk to tightly hold the fibers 20 together in the desired shape and orientation. The fibers 20 are sheared (cleaved and polished) with the fiber ends 21 being co terminally exposed at the inward end 29 of the bonding tube 50 as shown in FIG. 4. The bonding tube 56 extends substantially beyond the greater diameter surrounding tube 58 thus giving the overall ferrule 24 a profile which is thinner at each end and thicker in the center.

The key ring 30 is radially aligned upon the ferrule 24 such that the projecting tab 31 is precisely aligned with fiber 20-I. In the embodiment of the end assembly 319 shown in FIGS. 3-5 the orientation is further secured in position by using the ferrule holder 25. The ferrule holder 25 is placed about the ferrule 24 and includes a holder nut 60 oriented toward the inner end. The holder nut 60 includes a set of recessed key receivers 62 which provide a flat receiving channel for the projecting tab 31. A holder tube 64 extends from the holder nut 60 toward the outer end 23 and provides a resting surface for the key ring 30. Since, unlike the ferrule 24 itself, the ferrule holder 25 is not subject to compression forces, it provides a more uniform exterior surface upon which the key ring 30 may be rotated.

The key ring 30 is also longitudinally aligned such that it is separated from the inward end 29 by the optimal distance shown in FIGS. 1 and 6. When the key ring 30 is properly aligned both radially and longitudinally it is crimped onto and adhered by epoxy to the surrounding tube 58.

FIG. 6 shows the entire KSP connector 310 in assembled form and emphasizes the bulkhead 44, keyed housing 34 and C-sleeve 36 combination. In the KSP preferred embodiment 310 these three components are fused together for structural integrity. All are symmetrical about the bisecting plane 14 and generally radially symmetrical about the longitudinal axis 12. The C-sleeve 36 is a ceramic tube which serves to receive the inward ends 29 and position them precisely such that the central fiber 20-VII from each ferrule 24 is positioned precisely on the longitudinal axis 12. The precisely radially aligned key slots 32 on the keyed housing 34 act to receive the projecting tabs 31 of the key rings 30, thus aligning fiber 20-I from each blue ferrule 26 with the fiber 20-I of the corresponding red ferrule 28. Since the tight compression of bonding tube 56 maintains the appropriate radial alignment of the fibers 20 in either the clockwise orientation 52 or counter clockwise orientation 54 this results in each of the fibers 20-II through 20-VI also being mutually aligned. In this manner the connector 10 achieves optimal signal transmission in a consistent and easily achieved manner.

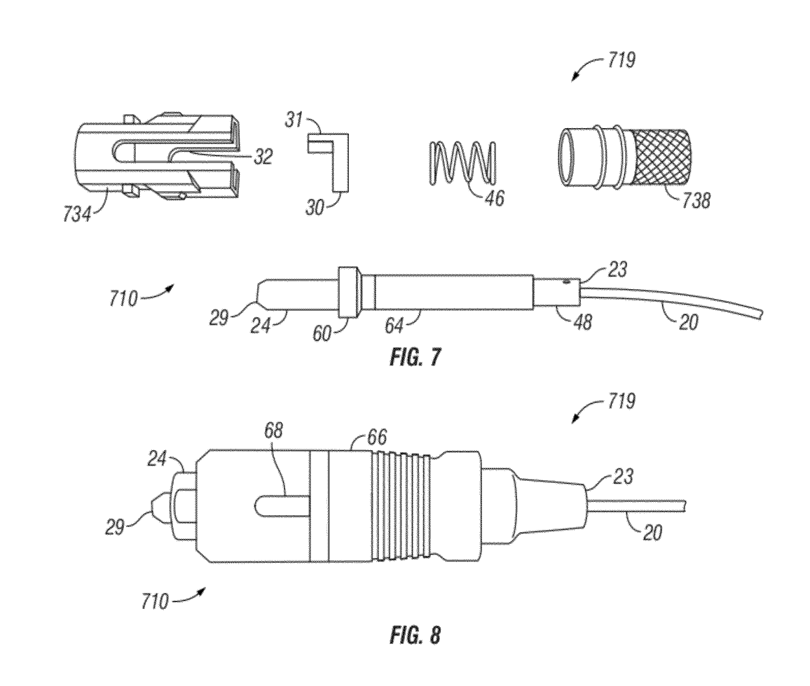

A further embodiment of the connector invention is illustrated in FIGS. 7 and 8 as a KCS end assembly 719. The KSC end assembly 719 is adapted to be plugged into a socket (not shown), as opposed to mating with another end assembly. In this case, the precise orientation is provided by the tight fit with the socket.

In the illustration of FIG. 7 the end assembly 719 is shown in an expanded fashion, pre-assembly mode. In many ways, the KSC end assembly 719 is similar to the KSP end assembly 319 in that a ferrule holder 25 is provided about the ferrule 24 and the orientation tube 48. However, the compression spring 46 is now oriented directly against the key ring 30 and a modified bayonet cap 738 is secured to the exterior of the holder tube during assembly to force the key protection 31 forward into the key slot 32 on the modified keyed housing 734.

In the fully assemble view of FIG. 8 it may be seen that a plug housing 66 has been secured about the entire exterior of the KSC end assembly 719. The plug housing 66 rotationally mates with and is secured to the modified keyed housing 734 such that a plug key 68 on the surface of the plug housing is precisely oriented with the key slot 32 and the projection tab 31 on the key ring 30. Thus the KSC end assembly 719 is precisely configured and aligned to mate with a similarly constructed socket.

Other arrays of fibers may be utilized in some circumstances, with bundles having different numbers or configurations of fibers than the seven fiber pattern described above. The present invention will be equally efficacious in such circumstances, since the use of an orientation alignment guide 48 and keyed alignment binding techniques will still result in optimal alignment and signal transmission.

Similarly, while the C-sleeve, key ring and receiving slot arrangement of the present invention are particularly elegant and efficient in achieving alignment, other alignment schemes are contemplated for achieving similar results.

The dimensions of the components are primarily dependent on the nature of the fibers to be connected and may vary widely from application to application. Many modifications to the above embodiment may be made without altering the nature of the invention. The dimensions and shapes of the components and the construction materials may be modified for particular circumstances.

While various embodiments have been described above, it should be understood that they have been presented by way of example only, and not as limitations.

### INDUSTRIAL APPLICABILITY

The fiber optic alignment and connector method and connector assemblies 10, 310 and 710 of the present invention are intended for use whenever it is desired to have a junction between fiber optic systems. It is particularly desirable when a diverse set of fiber optic cables 20 are gathered together into a discreet bundle 22 for transmission purposes.

Typically, a situation will be encountered where it is desirable to create a junction between/among groups of fiber optic fibers 20. These may include communications between diverse components and a central instrument or some other circumstance. In all such cases it will be necessary to achieve precise alignment in the junction such that signal from the desired discreet fiber is delivered to the corresponding discreet fiber at the other end of the connection.

A common and desirable configuration for fiber optic connections is a seven fiber array, such as may be found in the HEPTOPORT™ components from Valdor Fiber Optics, Inc. of Hayward, Calif. Seven fibers having the same diameters are conveniently organized into a radial bundle 22 with one fiber in the center and the other six equally radially spaced about the center. The preferred embodiment 10 is shown and described above as working with such a configuration. In many cases, fewer than all seven fibers will be active in a given application.

In a case where individual fibers are coming to the connection from diverse components (such as two each from three different sensors or instruments) the technician will gather the fibers and identify each one clearly as to its source and desired destination. The fibers will be identified as fibers 20-I through 20-VII as described above (with a “dummy” fiber being occasionally inserted to complete the array). These fiber ends 21 will then be inserted into the orientation guide 48 in either a clockwise orientation 52 or a counter clockwise orientation 54 depending on whether the fiber ends 21 are to be on the left side 16 or the right side 18 of the connector assembly 10.

An impact mount ferrule 24 is then placed about the oriented bundle 22 and the bonding tube 56 is compressed to secure the bundle 22 into radial position to form the end assembly 19, with the fiber ends 21 being aligned with the inward end 29 (possibly being trimmed off at that location). The identification of fiber 20-I is maintained and located. If the ferrule 24 is provided with a clockwise orientation 52 array at its inward end 29, it is colored blue and designated as a blue ferule 26, while a counter clockwise orientation 54 results in a ferrule 24 which is colored red and designated as a red ferrule 28. The fiber ends 21 on blue ferrules 26 and red ferrules 28 accordingly have mirror image arrays of fiber arrangement so that corresponding fibers 20-I through 20-VI may be directly opposed from each other.

The ferrule 24 is then keyed by placement of a key ring 30 about the surrounding tube 58 or the ferrule holder 25 in some embodiments. The projecting tab 31 of the key ring 30 is precisely radially aligned with the center of fiber 20-I and is then bonded into position on the ferrule 24, by crimping and or epoxy adhesive.

Of course, in some situations, the ferrules 24 on each side of a connection may be preexisting or have been factory fabricated, including a key ring 30. In this case, the technician may proceed directly to the connection.

When it comes time to join a blue ferrule 26 with a red ferrule 28 in a fiber optic junction, a connection kit of the present invention, including an integral keyed housing 34 with an interior C-sleeve 36 and a bulkhead 44 is brought to the location where it is desired to join the opposing ferrules 26 and 28. The blue ferrule 26 will be inserted into the keyed housing 34 from the left side 16 while the red ferrule 28 will be inserted from the right side. In each case the inward end 29 will slidably fit within the C-sleeve 36. The respective ferrules 24 will be rotated such that the projecting tab 31 on the key ring 30 aligns with the receiving slot 32 on the keyed housing 34. The ferrule is then pushed into deeper connection until the projecting tab 31 is lodged as far as it will go into the receiving slot 32. At this point the ferrule 24 is perfectly positioned for a good connection.

The ferrule 24 is finally secured into position by tightening the bayonet cap 38 into the bulkhead 44. Since the bayonet cap 38 spins freely about the ferrule 24, there is no disturbance of the alignment or positioning of the ferrule within the keyed housing 34 and C-sleeve 36. The compression spring 46 maintains inward axial pressure on the ferrule 24 as the bayonet cap is tightened to the bulkhead 44, thus providing resilient pressure to keep the ferrule 24 in proper position and optimal alignment. Once both the blue ferrule 26 and the red ferrule 28 have been attached and secured, the completed connection is ready for use. Disassembly is accomplished by merely unscrewing the bayonet caps 38 from the bulkhead 44 and pulling the ferrules 24 out.

As the above example makes clear, the method and apparatus of the present invention result in rapid and accurate connection of fiber optic bundles and are of great value in multiple applications.

For the above, and other, reasons, it is expected that the fiber optic connector 10 of the present invention will have widespread industrial applicability. Therefore, it is expected that the commercial utility of the present invention will be extensive and long lasting.

What is claimed is:

1. A fiber optic connector assembly, comprising:
a pair of opposed ferrules, each including a bundle of optical fibers organized into a radial orientation; and
a keyed connector for receiving each said ferrule in an opposing juxtaposition, wherein
each said ferrule is provided with a key ring including a projecting tab, said projecting tab being precisely radially aligned with a specific external fiber in said radial orientation; and
said keyed connector is provided with a pair of opposed receiving slots for receiving said projecting tabs from each said ferrule, such that said optical fibers are juxtaposed for optimal alignment and communication.

2. The fiber optic connector of claim 1, wherein
said pair of opposing ferrules includes a first ferrule and a second ferrule, said first ferrule and said second ferrule being color coded so as to be clearly differentiated from each other.

3. The fiber optic connector of claim 1, and further including
resilient means for urging said ferrules into optimal engagement with said receiving slots.

4. The fiber optic connector of claim 3, wherein
said resilient means is a U-spring.

5. The fiber optic connector of claim 3, wherein
said resilient means is compression spring situated within a threaded cap for securing said ferrules together in said connector.

6. The fiber optic connector of claim 1, wherein
said bundle of optical fibers is captured within an alignment guide to maintain the relative radial array of the individual fibers in said bundle.

7. The fiber optic connector of claim 1, and further including
a threaded bayonet cap and bulkhead structure having a bayonet cap associated with each said ferrule and a bulkhead for receiving each said bayonet cap to secure said ferrules together in said connector.

8. The fiber optic connector of claim 1, wherein
one of said opposed ferrules is encased within a socket, with said socket having a receiving slot aligned with said key ring and said projecting tab; and
the opposing one of said ferrules in encased in a plug adapted to mate with said socket.

9. In a fiber optic connector array for bundles of multiple discreet fibers, the improvement comprising:
orienting said discreet fibers into mirror-image arrays in opposing directionally-identified ferrules, and binding said fibers securely into said arrays;
placing a key ring on each said directionally-identified ferrule, such that said key ring is radially aligned with a specific identified exterior fiber within each said array; and
engaging opposing ones of said directionally-identified ferrules into opposite ends of a keyed housing and engaging said key rings with opposedly aligned receiving elements of said keyed housing such that said mirror-image arrays are aligned and juxtaposed for optimal optical throughput.

10. The improvement of claim 9, wherein
each said opposing directionally-identified ferrule is color coded to identify the orientation of said array.

11. The improvement of claim 9, wherein
each said key ring is provided with a projecting tab which is specifically aligned with a selected one of said fibers in said array.

12. The improvement of claim 9, wherein
each said opposing directionally-identified ferrule is urged by a spring into close juxtaposition with the other said ferrule within said connector.

13. A method for optimally aligning multiple optical fibers having truncated ends in a fiber optic connector system, in steps comprising:
A) orienting said fibers into one of two prescribed mirror-image radial arrays, dependent on the direction of said fibers, by using an orientation guide element;
B) bonding said oriented fibers into a bundle secured within a ferrule having an inward end corresponding to the truncated ends of said fibers, each said ferrule being identified depending on which of said prescribed radial arrays is present at said inward end;
C) orienting and securing a key ring to each said ferrule, each key ring including a projecting tab which is precisely radially aligned with a discreet one of said oriented fibers;
D) inserting said inner end of one of said ferrules having one of said prescribed radial arrays into one end of a keyed housing such that said projecting tab engages a receiving slot in said keyed housing, and inserting said inward end of another one of said ferrules having the mirror-image prescribed radial array into the opposing end of said keyed housing, and engaging said projecting tab of such ferrule with an opposedly aligned receiving slot, such that each said optical fiber is juxtaposed with a corresponding fiber in said opposing ferrule; and
E) securing each opposing ferrule in said juxtaposed position by applying resilient inward axial pressure thereon.

14. The method of claim 13 wherein
each said step is adapted to be performed under field conditions.

15. The method of claim 13 wherein
said orientation guide is a tube having individual tubes therewithin to maintain each said fiber within said prescribed array.

16. The method of claim 15 wherein
and exterior one said fiber in each said array is identified as a discreet fiber such that said key ring may be precisely aligned with said discreet fiber.

17. An end assembly for a fiber optic connector, comprising:
an orientation guide for orienting the several incoming optical fibers into a predetermined array with each fiber being identified as to its position in such array;
a ferrule bonded about said orientation guide to secure said fibers into an oriented bundle;
a key ring, including a protection tab, secured to said ferrule such that said projection tab is oriented precisely with an identified one of said optical fibers.

18. The end assembly of claim 17, wherein
said end assembly is adapted to interface with a keyed housing having a key slot for receiving said projection tab and maintaining precise orientation of said fibers.

19. The end assembly and keyed housing of claim 18, wherein
said end assembly is encompassed by a keyed plug; and
said keyed housing is incorporated into a keyed socket.

20. The end assembly and keyed housing of claim 18, wherein
resilient force is supplied to said ferrule by a spring such that optimal juxtaposition is provided between said end assembly and said keyed housing.
